(19) United States
(12) Patent Application Publication
(10) Pub. No.: US 2008/0223633 A1
(43) Pub. Date: Sep. 18, 2008

(54) Hybrid all-wheel drive train and vehicle

(76) Inventor: Richard J. Kim, Great Falls, VA (US)

Correspondence Address: Richard J. Kim, 1004 SPRINGVALE RD, GREAT FALLS, VA, 22066, US

(21) Appl. No.: 11/717,658

(22) Filed: Mar. 14, 2007

(51) Int. Cl. B60K 6/00

(52) U.S. Cl. 180/65.2; 903/904

(57) ABSTRACT

The disclosure relates to automotive technology, particularly relating to hybrid vehicles and their decoupled drive arrangements. A hybrid all-wheel drive vehicle is disclosed comprising a vehicle chassis, first propulsion means fixed to the chassis and second propulsion means. A first set of at least two wheels is driven by the first propulsion means and a second set of at least two wheels driven by at least one second propulsion means. A hybrid control is described.

### FIELD

The disclosure relates to automotive technology, particularly relating to hybrid vehicles and their drive arrangements.

### BACKGROUND

Hybrid vehicles are known. For example, various land vehicles, ranging from sedans, SUVs, and other four-wheeled automobiles now enjoy the hybrid technology. However, experiments that lead up to modern-day hybrid technology can trace back to as far as World War II, when during the war, the military investigated alternative propulsion means for its military vehicles. The exploration was mutual throughout the globe, with little known folklores ranging from diesel-powered German motorcycles to bio-fueled military transport vehicles, etc. Among the variety of early ideas, many have survived and continue to make their presence with varying degrees of success. For example, some proponents swear by the use of a bio-diesel technology, e.g., a plastic container in the trunk of a diesel car is used to hold vegetable oil as a switchable source of bio-fuel. There are commercially marketed solar-powered pedaled vehicles, usually produced overseas in limited quantities.

Some hold some resemblance to hybrid technology as we know today. Some were mere seeds of ideas that started from possibilities. Nevertheless, many of the past experiments were on the fringe of what would now be called hybrid technology, and would not be recognized as hybrid technology as we know it today. Rather, to an average consumer today, hybrid technology refers to a combination propulsion technology, most prominently, a combination power plant consisting of gasoline engine and electric motor drive coming together to drive a transmission. Nevertheless, a hybrid vehicle is not necessarily limited to what is on the market, but covers a broad scope of any conceivable combination of propulsion technology that can drive a vehicle.

All-wheel drive is becoming very popular in the automotive market. All-wheel drive vehicles distinguish themselves from four-wheel drive vehicles in that they typically don't standout as jeeps or all-terrain vehicles (ATV). In fact, many popular models come as regular sedan, or more realistically, luxury sedans. Accordingly, an all-wheel drive vehicle is popularly viewed as a luxury sedan adaptation of some of the best features of a jeep.

One aspect of an all-wheel drive feature is that there isn't a strict division of drive power like a four-wheel drive vehicle. Although there is a definite gear linkage of various manners between the four wheels when all-wheel drive is engaged, all-wheel drive refers to something more intelligently configured than a strict drive-train division of power between the four wheels. For example, there may be an intelligent engagement of select sets of wheels, unequal distribution of power between the wheels or wheel sets, part-time engagement of wheel sets not normally engaged, and other intelligently configured power train arrangement to better withstand adverse weather conditions. Nevertheless, regardless of what the vehicle is called, today's vehicle is powered either by one singular propulsion means, or is driven from one single transmission.

Although marketed as an intelligent alternative, all-wheel drive may in actually be referring to a weaker, limited adaptation of an otherwise two-wheel drive chassis, e.g., of a sedan, to have an all-wheel power train arrangement. Typically, such an adaptation of a sedan chassis is in reality not truly capable of providing the all-terrain capability of a jeep or an ATV due to its inherent vehicular design. Nevertheless, consumer markets have clearly chosen an all-wheel drive vehicle as a suitable compromise to meet their needs. In other words, smart consumers have time and again chosen the esthetics of a luxury sedan, yet the assured capacity to drive under adverse weather conditions of an all-wheel drive vehicle. Until today, this choice has meant paying a premium in sticker price and poorer miles-per-gallon (mpg) performance, when compared to a two-wheel drive version of the same model. All this is evident in the windshield sticker at the time of purchase.

According to the state-of-the-art, whether an all-wheel drive or a four-wheel drive vehicle, the very nature of the complex drive train being linked to one singular transmission source has always been the crux of the performance drag, cost premium, and poorer mpg performance. Accordingly, regardless of how many wheels are driven by which combination of hybrid power, according to the state-of-the-art, all of today's power train is based on a singular focal distribution of automotive power concentrated from one identifiable transmission.

The problem is real. The consumer must typically pay a premium for the all-wheel drive version, and must suffer a definite degradation in the mpg performance when compared to the two-wheel drive counterpart. Yet, despite the overt necessity in the market for a fuel-efficient, all-wheel drive vehicle that is affordable, this real need is treated in the automotive market as if it is a luxury option, just like a convertible rooftop. It's time for a real alternative that is intelligently configured and workable.

### SUMMARY

Applicant has sought to solve the problem of the inability of the automotive market to intelligently integrate all of the desirable features in today's automotive market. A consumer's need for the advantages of an all-wheel drive vehicle for an all-weather assured drivability without the typical disadvantages of an all-wheel drive vehicle is not truly met.

Applicant has disclosed a hybrid all-wheel drive vehicle, e.g., a four-wheeled land vehicle, one set of wheels being driven by one propulsion means, and another set of wheels being driven by another propulsion means.

Applicant has disclosed an all-wheel drive train adaptable to a land vehicle in which one set of wheels are driven by one propulsion means, and another set of wheels are driven by another propulsion means.

### BRIEF DESCRIPTION OF THE DRAWINGS

The exemplary hybrid all-wheel drive vehicle and method are variously illustrated in the following figures:

FIG. 1 shows an exemplary hybrid drive-train layout of a front-wheel-drive combustion-engine vehicle, with its rear wheels driven by a single electric motor via a differential axle;

FIG. 2 shows an exemplary hybrid drive-train layout of a rear-wheel-drive combustion-engine vehicle, with each of its front wheels driven by an independent electric motor; and

FIG. 3 shows an exemplary hybrid drive-train layout of a front-wheel-drive combustion-engine vehicle, with its rear wheels each driven by an independent electric motor.

### DETAILED DESCRIPTION

As a solution to the described cost-performance-feature dilemma, Applicant has explored the possibility of a hybrid drive train and vehicle that can intelligently offer all-wheel drive features.

The ultimate question that the applicant explored is whether a hybrid vehicle technology can offer an all-wheel drive capability that is intelligently configured so that the drive-train arrangement is not an overall drag in terms of cost, performance and efficiency, but rather represents a simplified intelligent power-train configuration that affords cost streamlining, performance enhancement and fuel efficiency.

### Distributed Drive Train

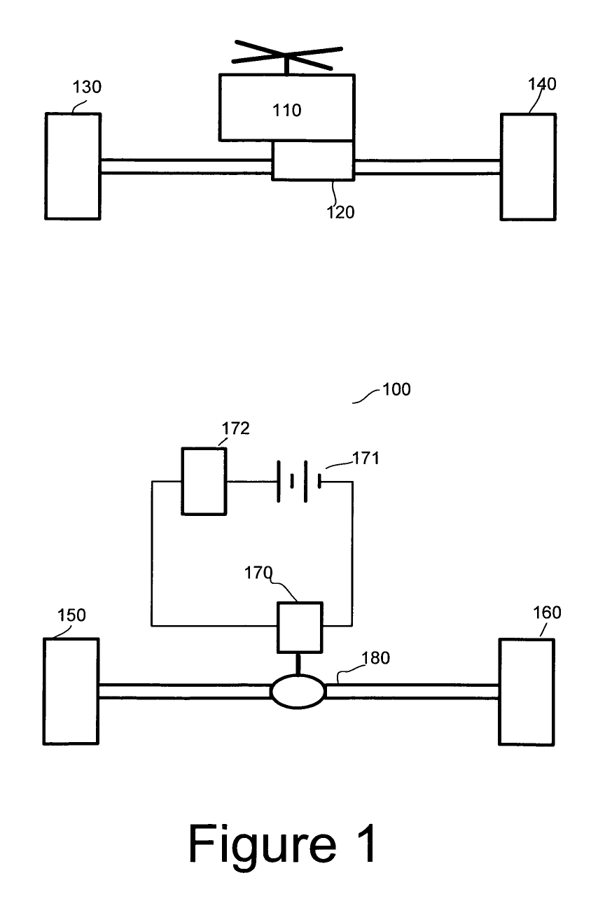

The solution in a decoupled, distributed drive train using at least two propulsion means. For example, FIG. 1 shows an exemplary hybrid drive-train layout of a front-wheel-drive combustion-engine vehicle 100, with its rear wheels 150, 160 driven by a single electric motor 170 via a differential axle 180. Here, the vehicle 100 utilizes a known front-wheel drive technology in that a combustion engine 110, e.g., a gasoline engine, ethanol engine, a diesel engine, or a bio-diesel engine, powers a transmission 120 to drive two front wheels 130 and 140. However, a single electric motor 170, e.g., any known A.C. or D.C. electric motor for driving a hybrid vehicle, separately powers a differential axle 180 to drive the real wheels 150 and 160. The motor 170 is energized by a known rechargeable batter 172, and is controlled by a controller 172 to power the motor 172. The two drive trains are decoupled. One mechanically works independently of another.

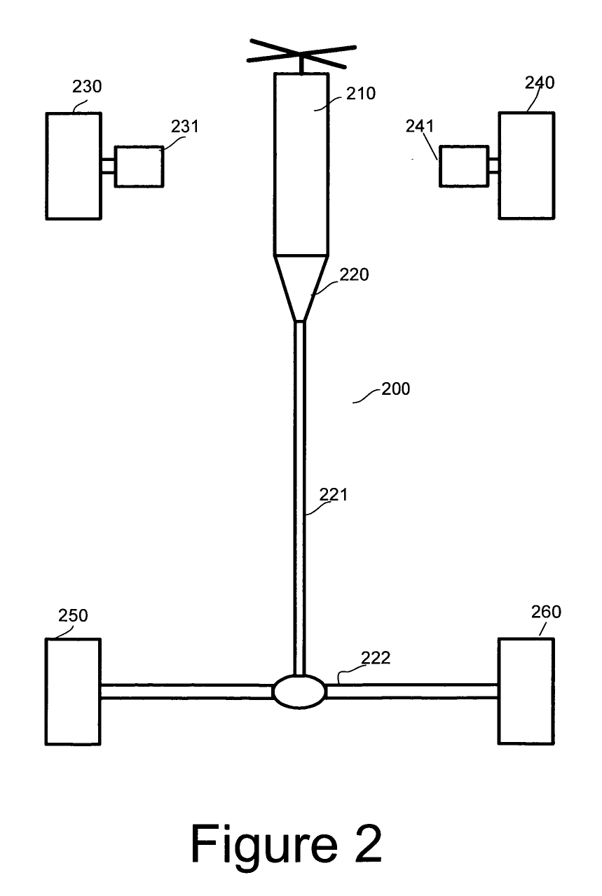

FIG. 2 shows an exemplary hybrid drive train layout of a rear-wheel-drive combustion-engine vehicle 200, with its front wheels 230 and 240 each driven by an independent electric motor 231 and 241. Here, the vehicle 200 utilizes a known rear-wheel drive technology in that a combustion engine 210, e.g., a gasoline engine, ethanol engine, a diesel engine, or a bio-diesel engine, powers a transmission 220 to drive two rear wheels 250 and 260. For example, the transmission 220 drives a drive shaft 221, which connects to a differential axle 222 via an appropriate universal joint, and thereby powers the rear wheels 250 and 260. This part of the drive train is known. However, an independent electric motor 231 or 241, e.g., any known A.C. or D.C. electric motor for driving a hybrid vehicle, independently drives a respective front wheel, 230 or 240. This again is Applicant's decoupling of propulsion means. An individual motor independently drives each respective front wheel, independent from each other and from the combustion engine. An exemplary control, e.g., the controller 172 of FIG. 1, and as further detailed herein, can unify the central control of all drive propulsions, e.g., engine 210, and motors 231 and 241. Accordingly, the disclosure teaches decoupled, independently operated propulsion means that are centrally controlled to coordinate the propulsion.

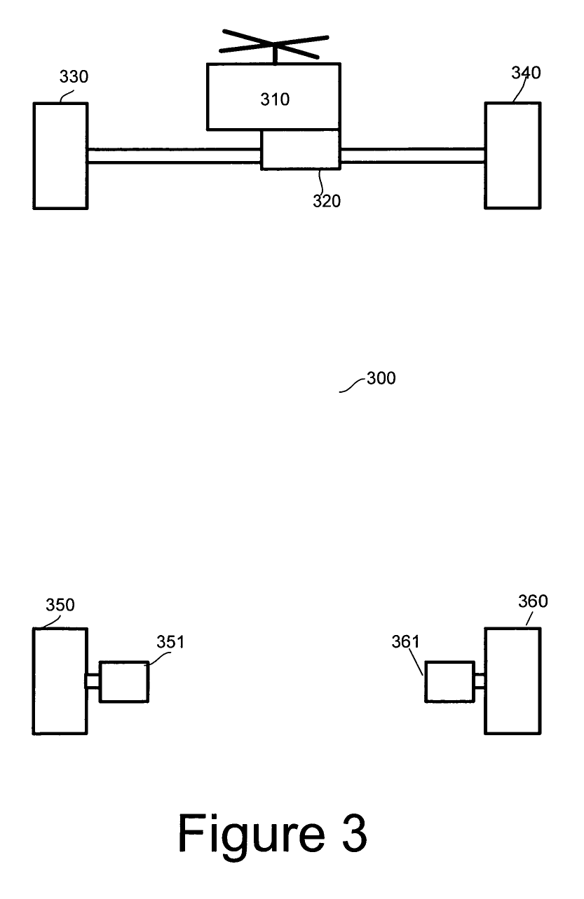

FIG. 3 shows an exemplary hybrid drive train layout of a front-wheel-drive combustion-engine vehicle 300, with its rear wheels 350 and 360 each driven by an independent electric motor 351 or 361, respectively. Here, the vehicle 300 utilizes a known front-wheel drive technology in that a combustion engine 310, e.g., a gasoline engine, ethanol engine, a diesel engine, or a bio-diesel engine, powers a transmission 320 to drive two front wheels 330 and 340 via a known drive train. However, an independent electric motor 351 or 361, e.g., any known A.C. or D.C. electric motor for driving a hybrid vehicle, powers a respective rear wheel, 350 or 360. This again is decoupling of propulsion means. An individual motor independently drives each respective rear wheel. An exemplary control, e.g., the controller 172 of FIG. 1, and as further detailed herein, can unify the central control of all drive propulsions, e.g., engine 310, and motors 351 and 361. Accordingly, the disclosure teaches decoupled, independently operated propulsion means that are centrally controlled to coordinate the propulsion.

In any of the exemplified configurations, the electric motors do not need to be of such a power rating that they need to furnish torque commensurate of that of a true four-wheel drive. The consumer market doesn't really ask for that. It's time to configure a vehicle that the consumer really wants: That the next vehicle purchased needs to be smartly configured to provide the traction necessary to get by in all weather conditions at an acceptable cost, performance, and fuel efficiency.

On the other hand, the multiple propulsion means can definitely complement each other to boost performance. Accordingly, a combustion engine, whether it is gasoline, diesel powered, ethanol or bio-diesel powered, need not be rated to the full vehicle performance rating, because the overall vehicle performance is in essence the sum of the performances yielded by the independent propulsion means that are available. Accordingly, this is true performance and efficiency with streamlined configuration.

### Motor Mount

In one exemplary embodiment, propulsion means, such as an electric motor, can be fixed to a chassis, and can utilize known jointed links, e.g., the propulsion means driving a jointed shaft which drives a suspended wheel. This is encompassed by Applicant's disclosure.

An alternative exemplary embodiment can be based propulsion mean fixed to a stable platform, such as an automotive chassis, to engage a drive wheel via a jointed shaft or axle, such as a differential axle. This is encompassed by Applicant's disclosure.

Alternatively, a drive motor itself can be compact, and in an alternate embodiment, the individual electric motor can be removed from the chassis itself, e.g., nestled in a suspension mechanism to drive the link wheel, or is integral to the wheel mechanism itself. For example, a compact electric motor can be formed integral with a disc assembly of a disc brake, nestled in a suspension arrangement, or even hidden within a wheel well. These alternate exemplary arrangements are also encompassed by the Applicant's disclosure.

### Power Generation

In the context of hybrid technology, the electric motor can in itself serve as the electric regeneration plant. That is, an electric motor that is used for a hybrid vehicle can also serve as an electric generator. This is a known technology, and is within the scope of the present disclosure. That is, the wheels that are powered by the electric motors can also at times generate electricity. This concept is known in the industry as power regeneration, e.g., during braking or coasting. This concept is also within the scope of the present disclosure.

Alternatively, power can be generated from a traditional alternator arrangement of a gasoline, ethanol, diesel, or bio-diesel combustion engine. This concept is also within the scope of the present disclosure.

Either concept in known configurations would work, because under Applicant's decoupled power-train arrangement, the electric power does not need to provide the level of torque matching the capacity of the combustion engine. Any significant capacity to provide power assist from an electric motor in an intelligently controlled manner can in reality meet the all-weather needs of a vehicle user. The electric-assisted drive does not need to be a dedicated drive of equal torque under all circumstances, and under such an under-powered electric assist arrangement, such a hybrid vehicle can still be in an all-wheel drive category.

This uneven power assist can prove to have its own advantages. First, all manners of components, including the electric motor, the electric battery and the drive train, can be deliberately designed to be unusually under rated compared to a full-blown hybrid vehicle. This is good for achieving the overall performance-efficiency-cost goal. Any such simplification can lead to reliability, superior performance, agility, and translate to simple cost savings.

### Hybrid Control

Hybrid control as a singular concept is known. However, Applicant has realized a unique requirement to control a hybrid of at least two decoupled drive trains powered independently. Accordingly, the hybrid control (e.g., 171) for an exemplary decoupled all-wheel drive configuration (e.g., FIG. 1) based on at least two independently powered drive trains is new, and is within the scope of the present disclosure.

One exemplary hybrid control can take advantage of a pure hybrid accelerator interface. By this, Applicant means an accelerator pedal which has the look and feel of an accelerator pedal, but which has no mechanical linkage to the respective power plant.

That is, the accelerator depression is translated into electric signals to an electric control to drive the respectively at least two power plants. This is Applicant's unique adaptation of known control concept for the purpose of coordinated control of at least two decoupled drive trains, and is encompassed by Applicant's present disclosure.

As a further exemplary hybrid electronic control, an electronic control can control both the at least one electric motor and the combustion engine based upon a combination of an accelerator depression and dashboard control settings. For example, the dashboard control can set operating conditions e.g., whether the vehicle is set for two-wheel drive, all-wheel drive, drive pavement, wet pavement, etc. This exemplary embodiment is encompassed by the present disclosure

Another exemplary embodiment can employ mechanical linkages from the accelerator to a throttling mechanism of a combustion engine and/or an electric power control. This exemplary embodiment is encompassed by the present disclosure.

Yet another exemplary hybrid control is a combination of mechanical linkages and electronic control. For example, an accelerator depression can result in movement of the throttle of a combustion engine, while at the same time, providing control input to an electronic control to the at least one electric motor.

These and other obvious variations to the exemplary embodiments Applicant has disclosed are all within the scope of the Applicant's disclosure. The claims as follows describe the actual scope of Applicant's invention.

1. A hybrid all-wheel drive vehicle, comprising:
a vehicle chassis;
first propulsion means fixed to the chassis;
at least one second propulsion means;
a first set of at least two wheels being driven by the first propulsion means;
a second set of at least two wheels having disc brakes, and driven by the at least one second propulsion means, each of the second propulsion means being formed integral with a disc assembly of a respective disc brake and hidden within a wheel well; and
hybrid control means.

2. The hybrid all-wheel drive vehicle according to claim 1, wherein the first propulsion means is a combustion engine chosen from the group comprising a gasoline engine, an ethanol engine, a diesel engine, and a bio-diesel engine; and each of the at least one second propulsion means is an electric motor suitable for a hybrid vehicle.

3. The hybrid all-wheel drive vehicle according to claim 1, wherein the first propulsion means is a primary propulsion means, and each of the at least one second propulsion means is a secondary propulsion means suitable for a hybrid vehicle.

4. The hybrid all-wheel drive vehicle according to claim 1, wherein the first set of wheels refers to front wheels, and the second set of wheels refers to rear wheels.

5. The hybrid all-wheel drive vehicle according to claim 1, wherein the first set of wheels refers to rear wheels, and the second set of wheels refers to front wheels.

6. The hybrid all-wheel drive vehicle according to claim 1, wherein each of the at least one second propulsion means is nestled in a respective suspension mechanism.

7. An all-wheel drive train adaptable to a land vehicle, comprising:
a first set of at least two wheels driven by first propulsion means, and
a second set of at least two wheels, each of the at least two wheels being linked to a suspension arrangement and driven by dedicated second propulsion means, each of the dedicated second propulsion means being nestled in the respective suspension arrangement, hidden within a wheel well.

8. The all-wheel drive train adaptable to a land vehicle according to claim 7, wherein the first propulsion means is chosen from the group comprising a gasoline engine, an ethanol engine, a diesel engine, and a bio-diesel engine; and the second propulsion means is an electric motor suitable for a hybrid vehicle.

9. The all-wheel drive train adaptable to a land vehicle according to claim 7, wherein the first propulsion means is a primary propulsion means, and the second propulsion means is a secondary propulsion means suitable for a hybrid vehicle.

10. The all-wheel drive train adaptable to a land vehicle according to claim 7, wherein the first set of wheels refers to front wheels, and the second set of wheels refers to rear wheels.

11. The all-wheel drive train adaptable to a land vehicle according to claim 7, wherein the first set of wheels refers to rear wheels, and the second set of wheels refers to front wheels.

12. The all-wheel drive train adaptable to a land vehicle according to claim 7, wherein the second propulsion means is nestled in a suspension mechanism.

13. An all-wheel drive train adaptable to a land vehicle, comprising:
a first set of at least two wheels driven by first propulsion means, and
a second set of at least two wheels having disc brakes, and being driven by two second propulsion means, the two second propulsion means being formed integral with a disc assembly of a respective disc brake nestled in a suspension arrangement.

14. The all-wheel drive train adaptable to a land vehicle according to claim 13, wherein the first propulsion means is chosen from the group comprising a gasoline engine, an ethanol engine, a diesel engine, and a bio-diesel engine; and the second propulsion means is an electric motor suitable for a hybrid vehicle.

15. The all-wheel drive train adaptable to a land vehicle according to claim 13, wherein the first propulsion means is primary propulsion means, and each of the second propulsion means is secondary propulsion means suitable for a hybrid vehicle.

16. The all-wheel drive train adaptable to a land vehicle according to claim 13, wherein the first set of wheels refers to front wheels, and the second set of wheels refers to rear wheels.
